(19) United States
(12) Patent Application Publication
(10) Pub. No.: US 2006/0027003 A1
(43) Pub. Date: Feb. 9, 2006

(54) Locking device for vehicle

(75) Inventor: Yuki Mizukura, Saitama (JP)

Correspondence Address: BIRCH STEWART KOLASCH & BIRCH, PO BOX 747, FALLS CHURCH, VA, 22040-0747, US

(73) Assignee: HONDA MOTOR CO., LTD., Tokyo (JP)

(21) Appl. No.: 10/992,669

(22) Filed: Nov. 22, 2004

(30) Foreign Application Priority Data
Nov. 25, 2003 (JP) 2003-394592

(51) Int. Cl. B60R 25/02

(52) U.S. Cl. 70/252

(57) ABSTRACT

To reduce stress on a key when used both as a key for a combination locking device including an ignition switch and a handlebar locking device and a key for a seat locking device and a lid locking device, in a locking device for a vehicle, and to miniaturize the seat locking device and the lid locking device. In a vehicle having, in addition to a handlebar locking device, a seat locking device for locking and/or unlocking accessories such as a storage room and a seat, a rectangular hole as a key insertion hole is provided up to the vicinity of an arm provided on an end of a shaft part of the seat locking device. When the key is inserted, an engaging position of tumblers provided in the shaft part and the key comes near a base of the key.

### CROSS-REFERENCE TO RELATED APPLICATIONS

The present application claims priority under 35 USC 119 to Japanese Patent Application No. 2003-394592 filed on Nov. 25, 2003 the entire contents of which are hereby incorporated by reference.

### BACKGROUND OF THE INVENTION

1. Field of the Invention

The present invention relates to a locking device for a vehicle.

2. Description of Background Art

A locking device for a vehicle, is known wherein the locking device locks the steering of a handlebar. In this device, an ignition switch may include shutters for covering a key insertion slot. See, for example, Japanese Patent No. 3431585.

FIG. 2 of Japanese Patent No. 3431585 will be described with reference to FIG. 7 of the drawings. Note that the reference numerals have been changed.

FIG. 7 is a side view showing a conventional locking device for a vehicle wherein a steering lock 304 is provided as the locking device for a vehicle. The steering lock 304 is attached to an upper end of a steering shaft 302, which is attached to a head pipe 301 so as to be rotatable. A top plate 303 is interposed therebetween.

The steering lock 304 is for releasing the engagement (that is, a locked state) of a lock pin 308 that protrudes from a lock main body part 307 including a key cylinder and a lock plate 311 attached to the head pipe 301, when an ignition key 306 is inserted into the steering lock 304 and turned therein. More specifically, the steering lock 304 releases the foregoing engagement by drawing the lock pin 308 into the lock main body part 307. The key insertion slot is provided in an end of the lock main body part 307 and is covered with shutters (not shown) which are provided in a cover 312. The steering lock 304 enables the insertion of the ignition key 306 into the lock main body part 307 by using a magnet key 313 to open the shutters.

In the steering lock 304 provided with the shutters for closing the key insertion slot as described above, the ignition key 306 is elongated for the cover 312 housing the shutters.

The ignition key 306 described above also often serves as, for example, a key for a lid locking device for locking or unlocking a lid of a storage part provided in the vehicle and for a seat locking device for locking or unlocking a seat of the vehicle.

The lid locking device and the seat locking device will be described below.

FIG. 8 is a cross-sectional view showing a conventional lid locking device. The lid locking device 320 includes: a body 321; a key cylinder 324 which is inserted into the body 321 so as to be rotatable and a key insertion hole 323 into which the ignition key 306 (see also FIG. 7) is inserted. Tumblers 326 . . . (“. . . ” hereinafter means a plurality of elements in the following description.) are provided which are movable perpendicularly to an axis of the key cylinder 324. A return spring 328 generates elastic force in a direction opposite to a rotational direction of the ignition key 306 when the ignition key 306 is inserted into the key cylinder 324 and the key cylinder 324 is rotated by means of the tumblers 326 . . . A cam 332 is attached to an inner shaft 331 integrally formed in an end of the key cylinder 324. The body 321 is attached directly to the lid.

The cam 332 sets the lid in a locked state by allowing the lid to be engaged with an unillustrated engaging part and releases engagement of the cam 332 and the engaging part, that is, unlocks the lid by turning the ignition key 306 to rotate the cam 332 around the inner shaft 331.

FIG. 9 is a cross-sectional view showing a conventional seat locking device. The seat locking device 340 includes: a body 341; a key cylinder 344 which is inserted into the body 341 so as to be rotatable and has a key insertion hole 343 into which the ignition key 306 is inserted. Tumblers 346 . . . are provided that are movable perpendicularly to an axis of the key cylinder 344. A return spring 348 generates elastic force in a direction opposite to a rotational direction of the ignition key 306 when the ignition key 306 is inserted into the key cylinder 344 and the key cylinder 344 is rotated by means of the tumblers 346 . . . An arm 352 is attached to an inner shaft 351 integrally formed in an end of the key cylinder 344.

The arm 352 is a portion for connecting a tip of a wire extending from a locking mechanism provided on an unillustrated seat side. By rotating the arm 352 around the inner shaft 351, the wire is drawn to unlock the locking mechanism on the seat side.

The lid locking device 320 shown in FIG. 8 has a short overall length since the number of the tumblers 326 . . . can be reduced as compared with the steering lock 304 (see FIG. 7). Thus, only a portion close to the tip of the ignition key 306 is inserted into the tumblers 326 . . . Accordingly, the length of the projection of the ignition key 306 from the key cylinder 324 is increased. Therefore, when the ignition key 306 is turned to transmit the turning force to the key cylinder 324 through the tumblers 326, a large moment and a large shear stress occur on the ignition key 306. Thus, stress on the ignition key 306 is increased.

Moreover, in the seat locking device 340 shown in FIG. 9, since the key cylinder 344 is elongated to shorten the length of the projection of the ignition key 306 from the key cylinder 344, the body 341 is accordingly elongated and the overall length of the seat locking device 340 is increased.

### SUMMARY AND OBJECTS OF THE INVENTION

It is an object of the present invention to reduce the stress on a key when used both as a key for a combination locking device including an ignition switch and a handlebar locking device and a key for a seat locking device and a lid locking device, in a locking device for a vehicle, and to miniaturize the seat locking device and the lid locking device.

The invention according to the present invention provides a vehicle having, in addition to a handlebar lock, a locking device for locking and/or unlocking accessories such as a storage box and a seat. A key insertion hole is provided up to the vicinity of an operating member provided on an end of an inner shaft of the locking device. Thus, when a key is inserted, an engaging position of tumblers provided in the inner shaft and the key comes near a base of the key.

It is possible to allow the engaging position of the tumblers provided in the inner shaft and the key to come near the base of the key, to insert the key all the way into the inner shaft and to dispose the tumblers in the vicinity of the key insertion hole.

The present invention provides a key that is also used as a key for a combination locking device for a motorcycle, which is provided with shutters covering a key insertion hole which is freely opened and closed and which includes an ignition switch and locks a handlebar.

The present invention makes it possible to lock and/or unlock the combination locking device for a motorcycle and accessories such as an inner box and a seat, by use of one key.

The present invention provides a locking device as a seat locking device wherein the key can be inserted all the way into the seat locking device.

The present invention provides a locking device as a lid locking device for a storage box wherein the key can be inserted all the way into the lid locking device for the storage box.

In the present invention, the key insertion hole is provided up to the vicinity of the operating member provided on the end of the inner shaft of the locking device. Thus, when the key is inserted, the engaging position of the tumblers provided in the inner shaft and the key comes near the base of the key. Accordingly, the key can be inserted all the way into the inner shaft, thus making it possible to reduce the moment and shear stress on the key and to reduce stress on the key. Moreover, the tumblers can be disposed in the vicinity of the key insertion hole and the overall length of the locking device can be shortened. Thus, miniaturization of the locking device can be achieved.

In the present invention, shutters cover the key insertion hole that are freely opened and closed. The key is used as the key for the combination locking device for a motorcycle, which includes the ignition switch and locks the handlebar. Thus, the combination locking device for a motorcycle and accessories such as the inner box and the seat can be locked and/or unlocked by use of one key. Accordingly, the number of parts can be reduced and costs can be reduced.

In the present invention, since the locking device is the seat locking device, the key can be inserted all the way into the seat locking device. Thus, it is possible to reduce the moment and shear stress on the key and to reduce the stress on the key. Moreover, the tumblers can be disposed in the vicinity of the key insertion hole and the overall length of the seat locking device can be shortened. Thus, miniaturization of the seat locking device can be achieved.

In the present invention, since the locking device is the lid locking device for the storage box, the key can be inserted all the way into the lid locking device for the storage box. Thus, it is possible to reduce the moment and the shear stress on the key and to reduce the stress on the key. Moreover, the tumblers can be disposed in the vicinity of the key insertion hole and the overall length of an inner box locking device can be shortened. Thus, miniaturization of the inner box locking device can be achieved.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a side view of a vehicle including a locking device according to the present invention;

FIG. 2 is a first cross-sectional view showing the locking device according to the present invention;

FIG. 3 is a second cross-sectional view showing the locking device according to the present invention;

FIG. 4 is a cross-sectional view of a combination locking device using the same key as that of the locking device according to the present invention;

FIGS. 5(a) to 5(c) are first operation diagrams showing operations of the locking device according to the present invention;

FIGS. 6(a) and 6(b) are second operation diagrams showing operations of the locking device according to the present invention;

FIG. 7 is a side view showing a conventional locking device for a vehicle

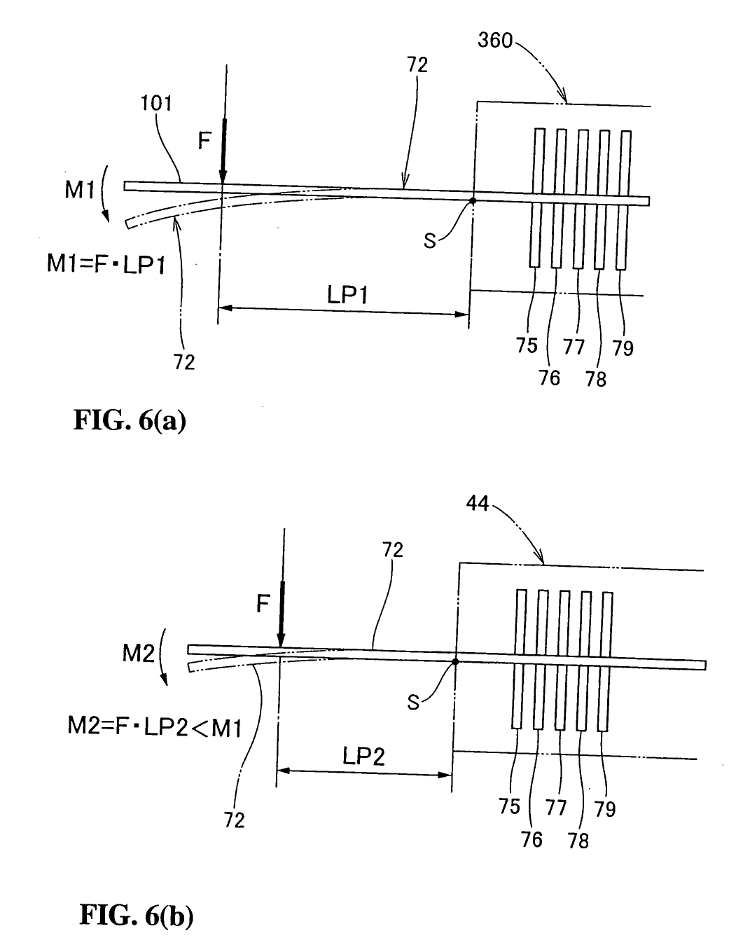

FIG. 8 is a cross-sectional view showing a conventional lid locking device; and

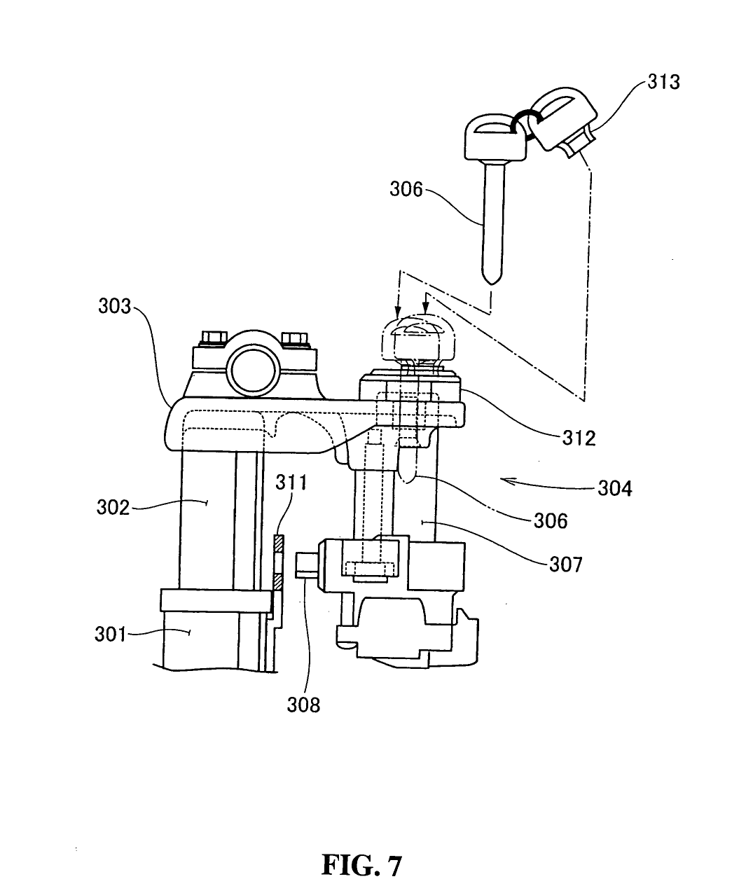

FIG. 9 is a cross-sectional view showing a conventional seat locking device.

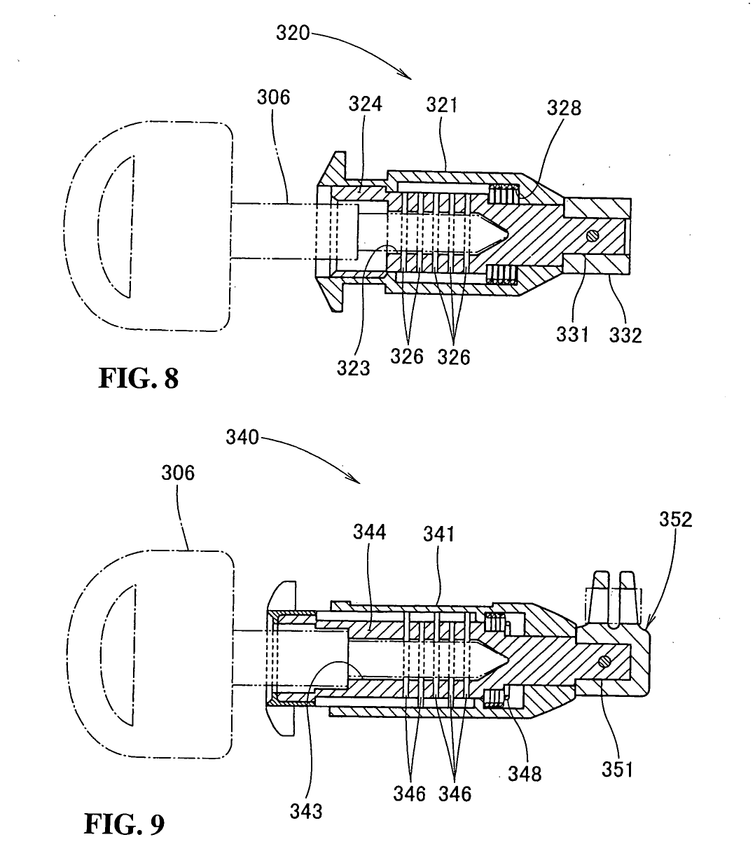

### DETAILED DESCRIPTION OF THE PREFERRED EMBODIMENTS

With reference to the drawings, an embodiment of the present invention will be described below.

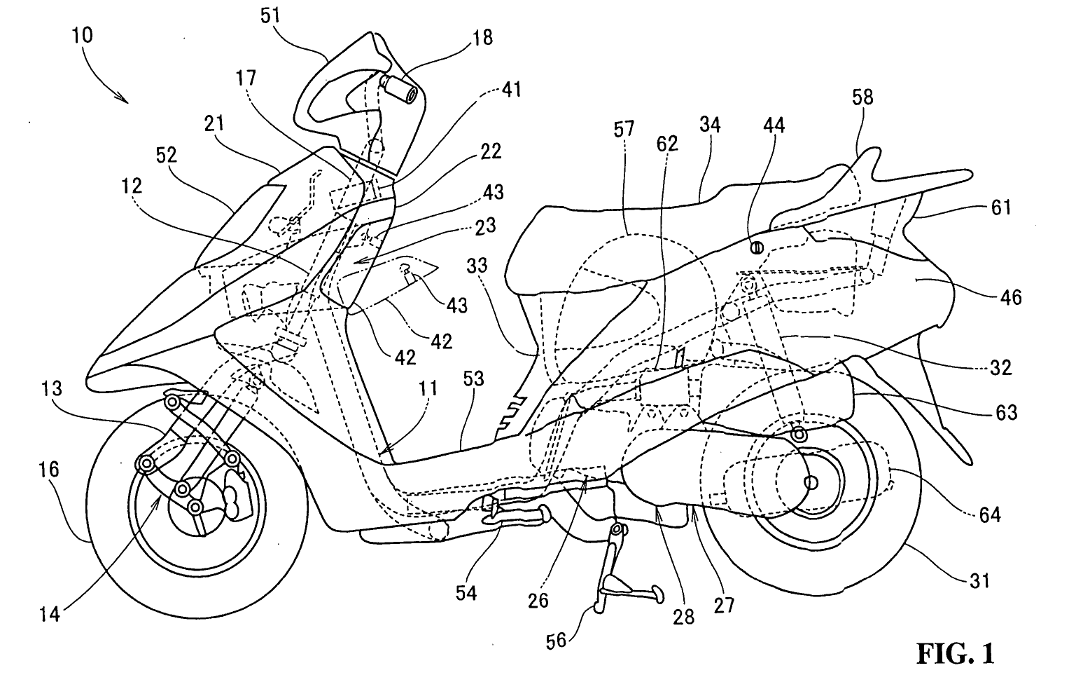

FIG. 1 is a side view of a vehicle including a locking device according to the present invention. The vehicle 10 is a scooter-type motorcycle, in which a head pipe 12 is provided in a front end of a vehicle body frame 11 for rotatably supporting an unillustrated steering shaft. A front fork 13 is attached to a lower end of the steering shaft with a front wheel 16 attached to the front fork 13 by means of a linking device 14. A handlebar post 17 is integrally provided in an upper end of the steering shaft with a handlebar 18 being attached to an upper portion of the handlebar post 17. Front portions of the head pipe 12 and the handlebar post 17 are covered with a front cover 21 with rear portions thereof being covered with a front inner cover 22 and a storage room 23 is provided in the front inner cover 22.

Moreover, in the vehicle 10, a rear portion of the vehicle body frame 11 swingably supports a power unit 28. The power unit 28 includes an engine 26 and a power transmission part 27. A rear wheel 31 is attached to a rear portion of the power unit 28 with a rear shock absorber 32 extending from a rear end of the power unit 28 and the rear portion of the vehicle body frame 11. A storage box 33 is attached in an upper rear portion of the vehicle body frame 11 with a seat 34 being attached to an upper portion of the storage box 33 so as to be openable and closable.

As illustrated in FIG. 1, a combination locking device 41 is attached to the handlebar post 17. The combination locking device is a part combining an ignition switch and a handlebar locking device for locking the steering of the handlebar 18.

A lid 42 is attached to the front inner cover 22 so as to be freely opened and closed for getting an object to be stored in and out of the storage room 23. A lid locking device 43 is attached to the lid 42 for locking the lid 42 in a closed locking state.

A seat locking device 44 is attached to a body cover 46, for covering the sides of the vehicle body. The seat locking device 44 locks the seat 34 in a closed state.

A handlebar cover 51 covers the handlebar 18. A head lamp 52 is mounted on the vehicle with a floor step 53 being provided on which a driver and a passenger position their feet. A side stand 54 is provided together with a main stand 56. A helmet 57 is stored in the storage box 33. A grab rail 58 is provided onto which a passenger hold the vehicle. A tail lamp 61 is mounted on the rear of the vehicle. A carburetor 62 is provided together with an air cleaner 63 and a muffler 64.

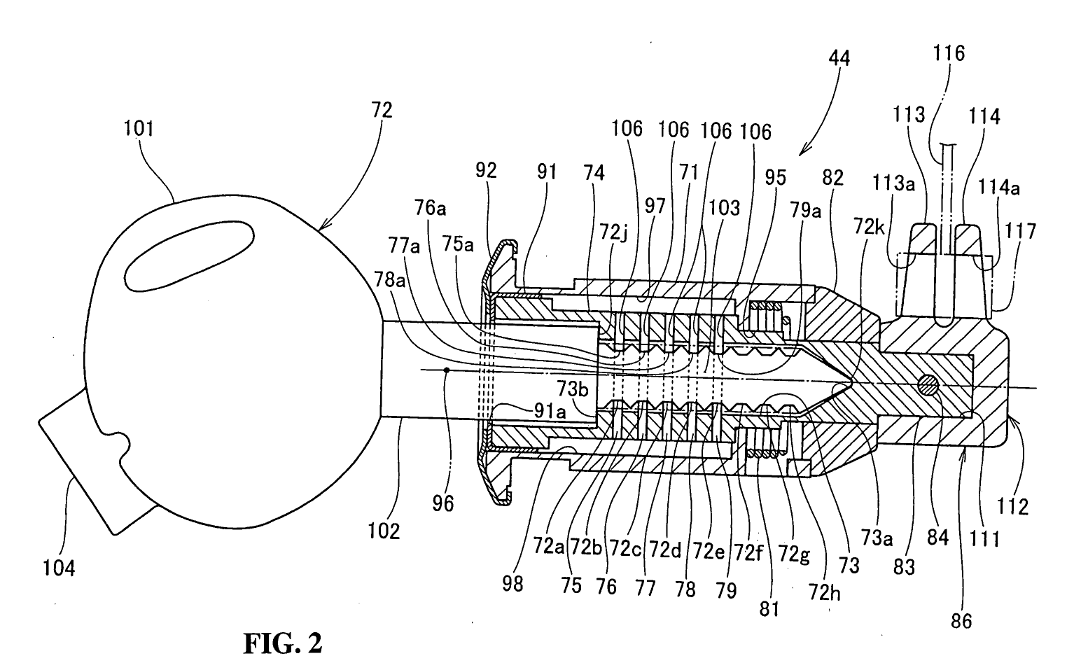

FIG. 2 is a first cross-sectional view showing the locking device according to the present invention. FIG. 2 shows the seat locking device 44 as the locking device.

More specifically, the seat locking device 44 includes: a cylindrical body 71; a key cylinder 74 which is rotatably housed in the body 71 and a key insertion hole 73 positioned therein for inserting a key 72. Plate-like tumblers 75 to 79 are provided in the key cylinder 74 so as to be movable perpendicularly to an axis. A return spring 81 generates an elastic force to rotate the key cylinder 74 in rotary direction with respect to the body 71 and returns the key cylinder 74 to its original rotational position when the key 72 is inserted into the key cylinder 74 and turned. A collar 82 is attached to one end of the body 71 for covering the return spring 81. An arm 86 is attached to a shaft part 83, which is integrally provided at a tip of the key cylinder 74, by use of a screw 84. An inner cover 91 is attached to one end of the key cylinder 74 and includes a rectangular hole 91a through which the key 72 enters. An outer cover 92 covers the other end of the body 71.

The body 71 includes a cylinder housing hole 95 which houses the key cylinder 74. In the body 71, engaging grooves 97 and 98 extending along a rotation axis 96 of the key cylinder 74 are formed in the cylinder housing hole 95.

The key 72 includes: a grip part 101 which is held by a hand; a center extended part 102 which extends from the grip part 101; and an end extending part 103 which extends from the center extended part 102. In the key 72, a magnet key 104 is provided in the grip part 101, and groove parts 72a to 72h are formed in edges of the end extending part 103 (reference numerals 72a to 72h indicating groove parts in one of the edges on both sides are omitted) so as to be symmetrical to each other across the rotation axis 96. A step part 72j is provided between the center extending part 102 and the end extending part 103. The key 72 is provided with a tip 72k.

The key insertion hole 73 is formed to have a bottom 73a with a V-shaped cross section with approximately the same shape as that of the V-shaped tip 72k of the key 72.

The key cylinder 74 is a member in which slots 106 . . . are formed in a direction perpendicular to the rotation axis 96. In these slots 106 the tumblers 75 to 79 are movably disposed.

The tumblers 75 to 79 have rectangular holes 75a, 76a, 77a, 78a and 79a into which the groove parts 72a to 72h of the key 72 are fitted when the key 72 is inserted into the key insertion hole 73 until the step part 72j of the key 72 hits against a step part 73b provided in the key insertion hole 73. The respective tumblers 75 to 79, which are engaged with the engaging groove 97 or the engaging groove 98 in the body 71 before the key 72 is inserted, are moved by fitting the groove parts 72a to 72h of the key 72 into the rectangular holes 75a, 76a, 77a, 78a and 79a of the tumblers 75 to 79. By releasing the engagement of the tumblers 75 to 79 and the engaging grooves 97 and 98, the key cylinder 74 can be rotated with respect to the body 71.

The return spring 81 is a torsion coil spring, which has one end attached to the body 71 and the other end attached to the key cylinder 74.

The arm 86 includes: a fitting part 112 having a shaft fitting hole 111 into which the shaft part 83 is fitted; and side projecting parts 113 and 114 which project laterally from the fitting part 112 and include attachment holes 113a and 114a. A cylindrical engaging member 117 attached to a tip of a wire 116 is engaged with the attachment holes 113a and 114a.

When the key 72 is inserted into the key cylinder 74 and turned, the arm 86 is swung around the shaft part 83 to draw the wire 116 connected to an unillustrated locking mechanism on the seat side. Accordingly, a seat locked by the locking mechanism on the seat side is unlocked, thus making it possible to open the seat 34 as illustrated in FIG. 1.

The bottom 73a of the key insertion hole 73 penetrates the return spring 81 and is provided up to a position where the bottom 73a overlaps with the collar 82 provided anterior to the return spring 81 when viewed from the side and up to the vicinity of the arm 86.

Although, in this embodiment, the seat locking device 44 is intended to unlock the seat lock, the seat locking device 44 may be intended to perform the seat lock.

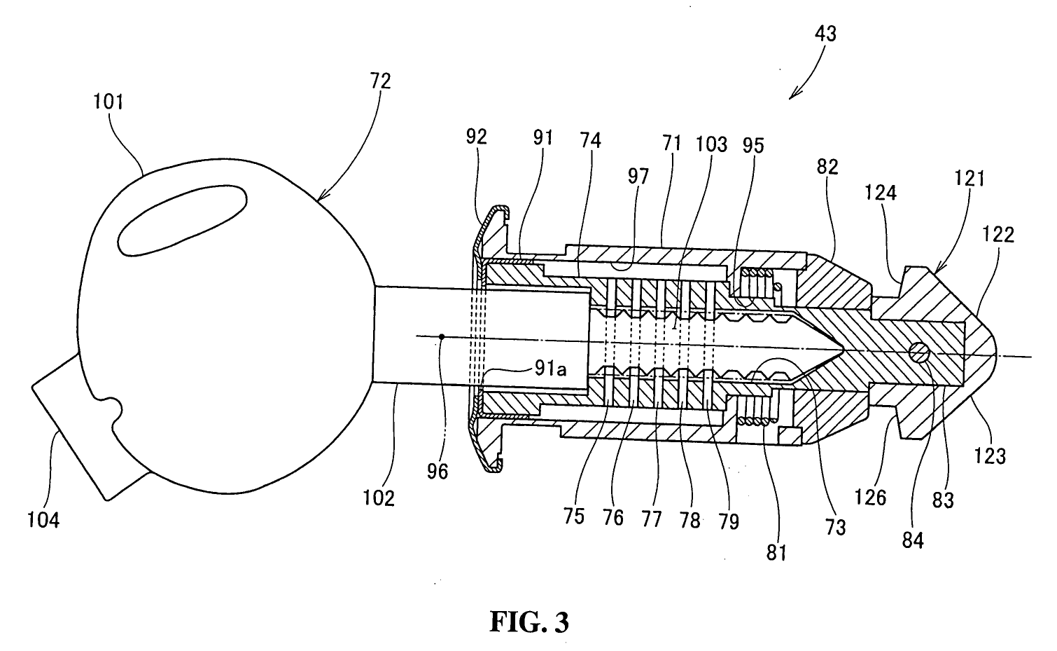

FIG. 3 is a second cross-sectional view showing the locking device according to the present invention. FIG. 3 shows the lid locking device 43 as a locking device for the storage box.

The lid locking device 43 is the locking device obtained by replacing the arm 86 (see FIG. 2) in the seat locking device 44 (see FIG. 2) with a cam 121, that is, attaching the cam 121 to the shaft part 83 by use of the screw 84.

The cam 121 includes inclined planes 122 and 123, hook parts 124 and 126 and the shaft fitting hole 111. The lid 42 (see FIG. 1) is locked in the closed state by engaging the hook parts 124 and 126 with an engaging hole provided in an inner wall portion of the storage room 23 (see FIG. 1). Meanwhile, the lid 42 can be opened by inserting the key 72 into the key cylinder 74 and turning the key 72 to release the engagement of the engaging hole and the hook parts 124 and 126. The inclined planes 122 and 123 are parts for facilitating the entrance of the cam 121 into the engaging hole wherein the opening width is made variable by use of an elastic member and the like.

Although, in this embodiment, the lid locking device 43 is intended to unlock the lid lock, the lid locking device 43 may be intended to perform the lid lock.

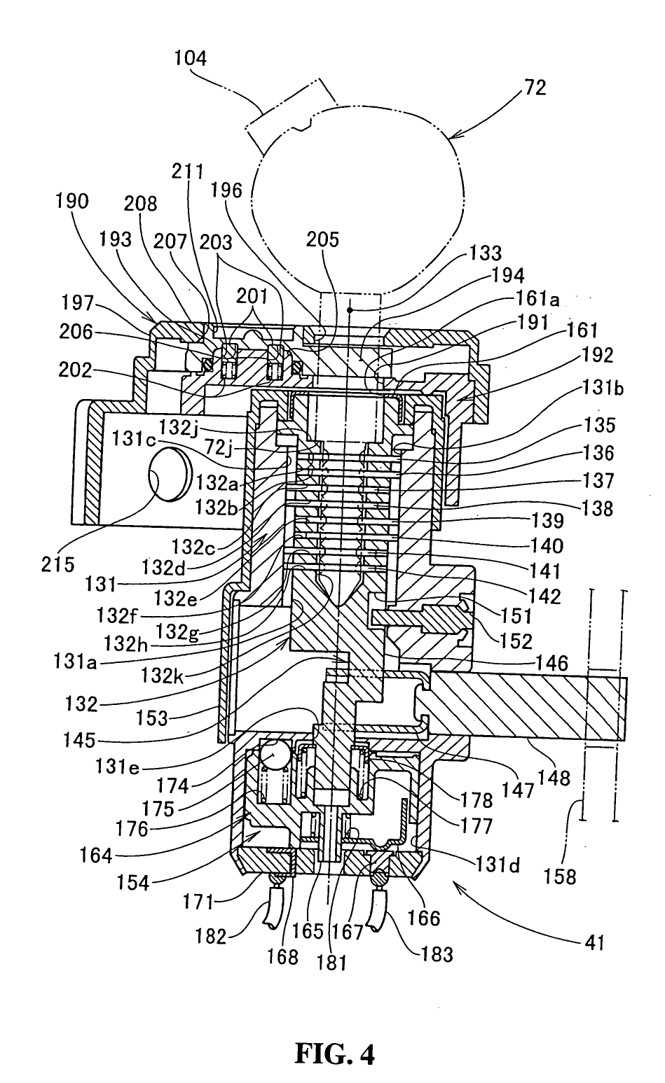

FIG. 4 is a cross-sectional view of a combination locking device for which the same key as that for the locking device according to the present invention is used. The combination locking device 41 is provided in the handlebar post 17 (see FIG. 1) and performs a handlebar lock by engaging a lock pin with the head pipe 12 (see FIG. 1) side.

The combination locking device 41 includes: a cylindrical body 131; a key cylinder 132 inserted into the body 131 so as to be rotatable; tumblers 135 to 142 provided in the key cylinder 132 so as to be movable perpendicularly to a rotary axis 133 of the key cylinder 132; a crank shaft 145 integrally provided on an end of the key cylinder 132; a U-shaped plate 147 swingably connected to a crank pin 146 of the crank shaft 145; a lock pin 148 attached to the U-shaped plate 147; a guide pin 152 attached to the body 131 to be inserted into a guide groove 151 provided in a side of the key cylinder 132; a body cover 153 for covering one end of the body 131; and a switch part 154 provided on the other end of the body 131.

A cylinder housing hole 131a is provided for housing the key cylinder 132 with engaging grooves 131b and 131c for engagement with the tumblers 135 to 142. A body concave part 131d is provided in the end portion of the body 131 for housing the switch part 154. A shaft supporting hole 131e is provided for supporting an end of the crank shaft 145 with slots 132a to 132h being provided in the key cylinder 132 for inserting the tumblers 135 to 142. A step part 132j is provided in the key cylinder 132 for receiving the step part 72j of the key 72. A key insertion hole 132k is provided in the key cylinder 132 for inserting the key 72. A lock plate 158 is attached to the head pipe 12 (see FIG. 1) to be engaged with the lock pin 148. A cylinder cover 161 is attached to the other end of the key cylinder 132.

The switch part 154 includes: a cylindrical turning part 164 attached to the end of the crank shaft 145 so as to be movable in an axial direction and to be rotatable integrally with the crank shaft 145. A moving contact 166 is attached to an end shaft part 165 projecting from the turning part 164 so as to be movable in the axial direction and to be rotatable integrally with the end shaft part 165. Fixed contacts 167 and 168 contact with the moving contact 166. A contact supporting member 171 is attached to an opening side of the body concave part 131d of the body 131 in order to support the fixed contacts 167 and 168.

Engaging concave part 174 . . . and 175 . . . are provided for stopping the key cylinder 132, the crank shaft 145 and the moving contact 166 at predetermined positions when the key 72 is turned (FIG. 4 shows only one reference numeral 174 and only one reference numeral 175, respectively). An engaging ball is fitted into the engaging concave part. A spring 176 is provided for pushes the engaging ball 175 into the engaging concave part 174. A spring 177 pushes the turning part 164 to the contact supporting member 171 side A spring bearing 178 is provided for holding one end of the spring 177. A spring 181 is provided for pushing the moving contact 166 onto the fixed contacts 167 and 168. Lead wires 182 and 183 are connected to the fixed contacts 167 and 168.

A shutter unit 190 is provided for closing a rectangular key insertion slot 161 a provided in the cylinder cover 161 of the combination locking device 41.

The shutter unit 190 includes: a base part 192 having a through-hole 191 through which the key 72 enters; a shutter main body 194 attached to a convex shaft part 193 swingably provided in the base part 192; and a cover member 197 for covering the base part 192 and the shutter main body 194. A through-hole 196 is provided through which the key 72 enters.

The convex shaft part 193 of the base part 192 includes magnet housing concave parts 203 and 203 for housing a magnet 201 and a spring 202 for pushing the magnet 201 to the shutter main body 194 side, respectively.

The shutter main body 194 includes a shutter side concave part 205 into which the convex shaft part 193 of the base part 192 is fitted. In a bottom of the shutter side concave part 205, magnet engaging concave parts 206 and 206, with which the magnets 201 and 201 are engaged, are formed. In a position close to the shutter side concave part 205, a magnet key connection convex part 208 is formed, which is fitted into a through-hole 207 rotatably provided in the cover member 197. In the magnet key connection convex part 208, a magnet key insertion hole 211 is provided, into which the magnet key 104 of the key 72 is inserted.

The cover member 197 includes an attachment hole 215 for attaching the device to the handlebar post 17 (see FIG. 1).

When the magnet key 104 including a magnet is inserted into the magnet key insertion hole 211, the magnet of the magnet key 104 and the magnets 201 and 201 of the shutter main body 194 repel each other. Accordingly, the magnets 201 and 201 are pushed into the magnet housing concave parts 203 and 203 against the elastic force of the springs 202 and 202, and the magnets 201 and 201 are detached from the magnet engaging concave parts 206 and 206 in the shutter main body 194. Thus, when the magnet key 104 is turned, the shutter main body 194 swings with respect to the base part 192 and the key insertion slot 161a of the key cylinder 132 is released to the outside through the through-hole 191 of the base part 192 and the through-hole 196 of the cover member 197. Consequently, the key 72 can be inserted into the through-hole 196, the through-hole 191, the key insertion slot 161a and the key insertion hole 132k.

Next, the operation of the above-described locking device will be described.

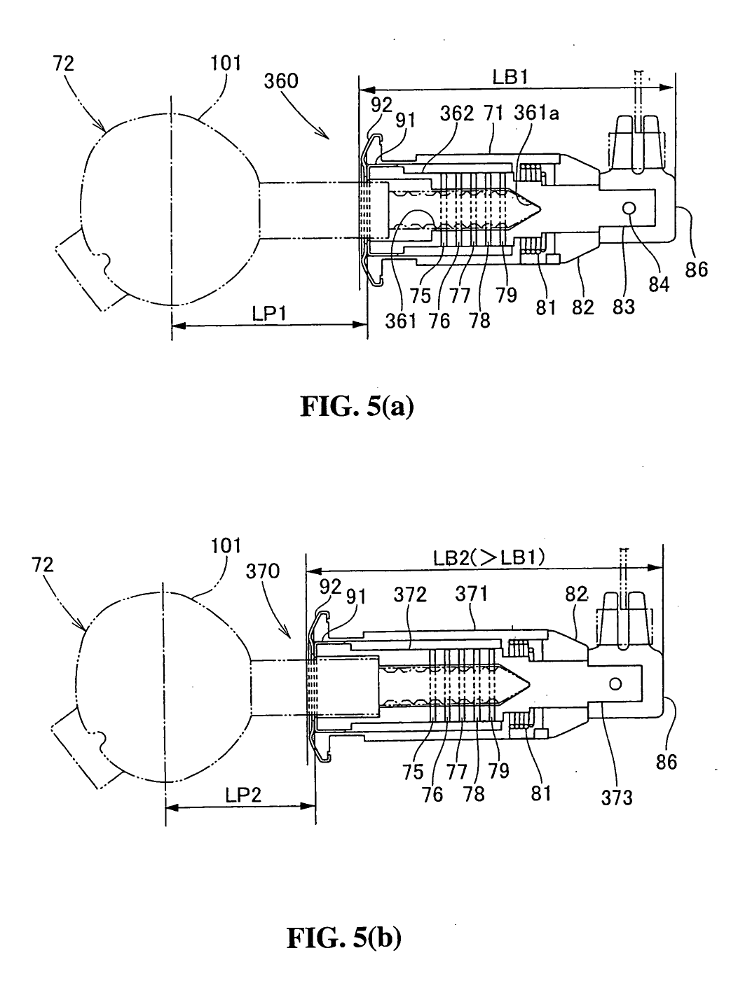

FIGS. 5(a) to 5(c) are first operational diagrams showing the operations of the locking device according to the present invention. FIG. 5(a) shows comparative example 1, FIG. 5(b) shows comparative example 2 and FIG. 5(c) shows the example (this embodiment).

In FIG. 5(a), a locking device 360 of comparative example 1 includes: the body 71; a key cylinder 362 which is housed in the body 71 so as to be rotatable and a key insertion hole 361 for inserting the key 72. Tumblers 75 to 79 are provided in the key cylinder 362 so as to be movable perpendicularly to the axis. The return spring 81; the collar 82; and the arm 86 are attached to the shaft part 83 by use of the screw 84.

A bottom 361a of the key insertion hole 361 in the key cylinder 362 is positioned close to the tumbler 79. When the key 72 is inserted into the key insertion hole 361, the tumblers 75 to 79 are turned only by a portion close to the tip of the key 72. Because of the structure described above, the key 72 projects significantly from the locking device 360. A length of the projection from the inner cover 91 attached to an end of the key cylinder 362 (that is, a distance between the inner cover 91 and the grip part 101) is set to LP1. Moreover, the overall length of the locking device 360 is set to LB1.

In FIG. 5(b), a locking device 370 of comparative example 2 includes a body 371 and a key cylinder 372 provided in the body 371. Tumblers 75 to 79 are provided in the key cylinder 372. The return spring 81 is provided together with the arm 86 attached to a shaft part 373 integrally provided in the key cylinder 372, the inner cover 91 attached to an end of the key cylinder 372, and the outer cover 92 attached to an end of the body 371. In the locking device 370, the body 371 and the key cylinder 372 are elongated, as compared with those of the locking device 360 of comparative example 1 shown in FIG. 5(a).

In the locking device 370, since the body 371 and the key cylinder 372 are elongated, a length of the projection LP2 of the key 72 from the locking device 370 becomes shorter than the length of the projection LP1 (see FIG. 5(a)). However, the overall length LB2 of the locking device 370 becomes longer than the overall length LB1 (see FIG. 5(a)).

As compared with the foregoing comparative examples 1 and 2 shown in FIGS. 5(a) and 5(b), in the seat locking device 44 of the example shown in FIG. 5(c), the key insertion hole 73 is provided up to the vicinity of the arm 86 attached to the shaft part 83 of the key cylinder 74. Moreover, when the key 72 is inserted into the key insertion hole 73, the engaging position of the tumblers 75 to 79 and the key 72 comes near a base of the key 72.

Thus, the length of the projection LP2 of the key 72 from the seat locking device 44 can be shortened and the overall length LB1 of the seat locking device 44 can be shortened.

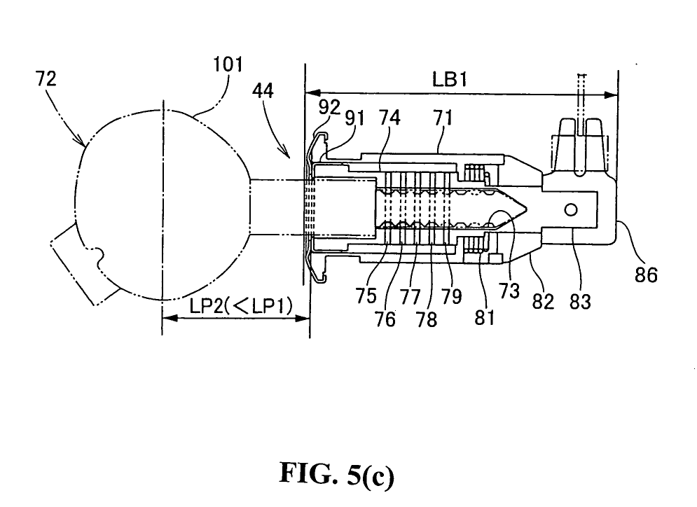

FIGS. 6(a) and 6(b) are second operational diagrams showing the operation of the locking device according to the present invention. Both FIGS. 6(a) and 6(b) show a state wherein the key 72 is engaged with the tumblers 75 to 79 as the device is viewed from the edge side of the key 72.

In FIG. 6(a), if the length of projection LP1 of the key 72 from the locking device 360 is large, torsional stress acts on the key 72 when the key 72 is turned by gripping the grip part 101.

If twisting the key 72 by use of the torsional stress described above is equivalent to the bending of a cantilever as the key 72 is turned by use of the force F, the bending moment M1 at a fixed support point S (which is equivalent to the key insertion slot 161a shown in FIG. 4) of the key 72 is M1=F·LP1.

In FIG. 6(b), when the length of projection LP2 of the key 72 from the seat locking device 44 is small, the bending moment M2 at the fixed support point S of the key 72 is M2=F·LP2. Moreover, LP2<LP1, M2<M1 is established.

In FIGS. 6(a) and 6(b), since the bending moment M2 of the key 72 inserted into the seat locking device 44 is smaller than the bending moment M1 of the key 72 inserted into the locking device 360, bending stress on the key 72 in the seat locking device 44 is reduced. Moreover, since shear stress on the key 72 is reduced, shear stress on the key 72 in the seat locking device 44 is also reduced.

As described above with reference to FIGS. 1 to 4, a first aspect of the present invention is that, in the vehicle 10 having, in addition to the combination locking device 41 as the handlebar lock, the lid locking device 43 and the seat locking device 44, which are for locking and/or unlocking accessories such as the storage room 23 as the storage box and the seat 34, the rectangular hole 91a as the key insertion hole is provided up to the vicinity of the cam 121 and the arm 86 as the operating members are provided on the end of the shaft part 83 as the inner shaft of the lid locking device 43 or the seat locking device 44. When the key is inserted, the engaging position of the tumblers 75 to 79 provided in the shaft part 83 and the key 72 comes near the base of the key 72.

Since the key 72 can be inserted all the way into the shaft part 83, the moment and shear stress on the key 72 can be reduced and the stress on the key 72 can be reduced. Moreover, the tumblers 75 to 79 can be disposed in the vicinity of the rectangular hole 91a, and the overall lengths of the lid locking device 43 and the seat locking device 44 can be shortened. Thus, miniaturization of the lid locking device 43 and the seat locking device 44 can be achieved.

A second aspect of the present invention is that the key 72 is also used as the key 72 for the combination locking device 41 for a motorcycle, which is provided with the shutter main body 194 as the shutters covering the rectangular hole 91a which are freely opened and closed and which include the switch part 154 as the ignition switch and a lock for the handlebar 18.

The key 72 is also used as the key 72 for the combination locking device 41 for a motorcycle, which is provided with the shutter main body 194 covering the rectangular hole 91a to be freely opened and closed and which includes the switch part 154 and locks the handlebar 18. Thus, the combination locking device 41 for a motorcycle and the accessories such as the storage room 23 and the seat 34 can be locked and/or unlocked by use of one key 72. Accordingly, the number of parts can be reduced and costs can be reduced

A third aspect of the present invention is that the locking device is the seat locking device 44. Since the locking device is the seat locking device 44, the key 72 can be inserted all the way into the seat locking device 44. Thus, the moment and shear stress on the key 72 can be reduced and the stress on the key 72 can be reduced. Moreover, the tumblers 75 to 79 can be disposed in the vicinity of the rectangular hole 91a, and the overall length of the seat locking device 44 can be shortened. Thus, the miniaturization of the seat locking device 44 can be achieved.

A fourth aspect of the present invention is that the locking device is a lid locking device 43. Since the locking device is the lid locking device 43, the key 72 can be inserted all the way into the lid locking device 43. Thus, the moment and shear stress on the key 72 can be reduced and the stress on the key 72 can be reduced. Moreover, the tumblers 75 to 79 can be disposed in the vicinity of the rectangular hole 91a, and the overall length of the lid locking device 43 can be shortened. Thus, the miniaturization of the lid locking device 43 can be achieved.

Note that, the locking device of the present invention may be adopted as the device for locking or unlocking a cap of a fuel tank.

The locking device for a vehicle according to the present invention is suitable for two-wheeled and four-wheeled vehicles.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A locking device for a vehicle comprising:
a handlebar lock;
a locking device for locking and/or unlocking accessories such as a storage box and a seat; and
a key insertion hole being provided up to the vicinity of an operating member provided on an end of an inner shaft of the locking device;
wherein when a key is inserted, an engaging position of tumblers provided in the inner shaft and the key comes near a base of the key.

2. The locking device for a vehicle according to claim 1, wherein the key is also used as a key for a combination locking device for a motorcycle, which is provided with shutters covering a key insertion hole to be freely opened and closed and which includes an ignition switch and locks a handlebar.

3. The locking device for a vehicle according to claim 1, wherein the locking device is a seat locking device.

4. The locking device for a vehicle according to claim 1, wherein the locking device is a lid locking device for a storage box.

5. The locking device for a vehicle according to claim 1, wherein shear stress on the key is reduced by inserting the key within the key insertion hole and engaging the tumblers on a portion of the key disposed directly adjacent to the base of the key.

6. The locking device for a vehicle according to claim 1, wherein the locking device is miniaturized by disposing the tumblers in the vicinity of the key insertion hole and enabling an actuation of the lock by having the tumblers engage a portion of the key disposed directly adjacent to the base of the key.

7. The locking device for a vehicle according to claim 1, wherein a bending moment of the key is reduced by having the tumblers engage a portion of the key disposed directly adjacent to the base of the key.

8. The locking device for a vehicle according to claim 1, wherein the locking device includes a shaft part for locking and unlocking and said key is inserted substantially all the way within the shaft part for reducing the moment and shear stress on the key when the key is rotated.

9. The locking device for a vehicle according to claim 8, wherein the locking device is miniaturized by disposing the tumblers in the vicinity of the key insertion hole and enabling an actuation of the lock by having the tumblers engage a portion of the key disposed directly adjacent to the base of the key.

10. The locking device for a vehicle according to claim 1, wherein a length of the key projecting from the key insertion hole is reduced and the overall length of the locking device is reduced by disposing the tumblers in the vicinity of the key insertion hole and enabling an actuation of the lock by having the tumblers engage a portion of the key disposed directly adjacent to the base of the key.

11. A locking device for a vehicle comprising:
a handlebar lock;
an ignition switch for actuating the vehicle;
said locking device being selectively actuated for actuating said ignition switch and said locking device including an operating member being selectively actuated for actuating said handlebar lock;
a key insertion hole being provided to extend to a point adjacent to said operating member provided on an end of an inner shaft of the locking device; and
tumblers for said locking device being disposed adjacent to said key insertion hole;
wherein when a key is inserted the tumblers provided in the inner shaft engage a portion of key disposed adjacent to a base of the key.

12. The locking device for a vehicle according to claim 11, wherein the key is adapted to be used as a key for a combination locking device for a motorcycle, which is provided with shutters covering a key insertion hole to be freely opened and closed and which includes an ignition switch and locks a handlebar.

13. The locking device for a vehicle according to claim 11, wherein the locking device may be used as a seat locking device.

14. The locking device for a vehicle according to claim 11, wherein the locking device may be used as a lid locking device for a storage box.

15. The locking device for a vehicle according to claim 11, wherein shear stress on the key is reduced by inserting the key within the key insertion hole and engaging the tumblers on the portion of the key disposed directly adjacent to the base of the key.

16. The locking device for a vehicle according to claim 11, wherein the locking device is miniaturized by disposing the tumblers in the vicinity of the key insertion hole and enabling an actuation of the lock by having the tumblers engage the portion of the key disposed directly adjacent to the base of the key.

17. The locking device for a vehicle according to claim 11, wherein a bending moment of the key is reduced by having the tumblers engage the portion of the key disposed directly adjacent to the base of the key.

18. The locking device for a vehicle according to claim 11, wherein the locking device includes a shaft part for locking and unlocking and said key is inserted substantially all the way within the shaft part for reducing the moment and shear stress on the key when the key is rotated.

19. The locking device for a vehicle according to claim 18, wherein the locking device is miniaturized by disposing the tumblers in the vicinity of the key insertion hole and enabling an actuation of the lock by having the tumblers engage the portion of the key disposed directly adjacent to the base of the key.

20. The locking device for a vehicle according to claim 11, wherein a length of the key projecting from the key insertion hole is reduced and the overall length of the locking device is reduced by disposing the tumblers in the vicinity of the key insertion hole and enabling an actuation of the lock by having the tumblers engage the portion of the key disposed directly adjacent to the base of the key.
